(19) United States
(12) Patent Application Publication
(10) Pub. No.: US 2016/0323659 A1
(43) Pub. Date: Nov. 3, 2016

(54) TIRE SENSOR-BASED MILEAGE TRACKING SYSTEM AND METHOD

(71) Applicant: The Goodyear Tire & Rubber Company, Akron, OH (US)

(72) Inventors: Kanwar Bharat Singh, Stow, OH (US); Amrita Patel, Greenville, NC (US); Peter Jung-min Suh, Copley, OH (US)

(21) Appl. No.: 14/698,939

(22) Filed: Apr. 29, 2015

(51) Int. Cl. H04Q 9/14; G06K 19/07

(52) U.S. Cl. CPC H04Q 9/14; G06K 19/0723

(57) ABSTRACT

A tire tracking system and method for tracking travel mileage experienced by a vehicle tire includes a tire-affixed identification transponder operative to generate tire-specific identification data; a vehicle-based incremental vehicle travel distance estimator for generating a synchronous stream of incremental vehicle travel distance estimations; and a timestamp synchronization and distance traveled estimator operative to generate a continuous synchronous stream of incremental tire travel distance estimations from the incremental vehicle travel distance estimations. A mobile network uploads the incremental tire travel distance estimations and the tire-specific identification data to a remote server that generates an aggregate of the tire travel distance estimations in a form accessible by the tire-specific identification data.

### FIELD OF THE INVENTION

The invention relates generally to tire monitoring systems for collecting measured tire parameter data during vehicle operation and, more particularly, to systems utilizing tire sensor-sourced data in determining experiential service mileage on the tire.

### BACKGROUND OF THE INVENTION

Tires age generally sold having a manufacturer-specified mileage rating. Such tires are represented as being functional for the mileage for which they are rated. However, users may fail to monitor the mileage on a tire in order to assess how much of the rated mileage for the tire remains. This is true particularly when the tires on a vehicle are of different age, having been placed into service at different times. The tires may further have experienced rotation on the vehicle during regular maintenance, causing the owner to lose track of the mileage on each tire. Consequently, the user of the vehicle may resort to speculation as to the mileage on each vehicle when deciding when to replace the tire.

There remains, accordingly, a need for a reliable, durable, and robust system and method for tracking the mileage on a tire for the purpose of indicating when the rated mileage for the tire has been reached.

### SUMMARY OF THE INVENTION

In one aspect of the invention, a tire tracking system and method for tracking travel mileage experienced by a vehicle tire includes a tire-affixed identification transponder operative to generate tire-specific identification data, a vehicle-based incremental vehicle travel distance estimator for generating a synchronous stream of incremental vehicle travel distance estimations and a timestamp synchronization and distance traveled estimator operative to generate a continuous synchronous stream of incremental tire travel distance estimations from the incremental vehicle travel distance estimations. A mobile network uploads the incremental tire travel distance estimations and the tire-specific identification data to a remote server that generates an aggregate of the tire travel distance estimations in a form accessible by the tire-specific identification data.

In another aspect, a tire-mounted temperature sensor and a tire-mounted pressure sensor are mounted to the vehicle tire to operatively generate respectively tire-specific historical temperature data and tire-specific historical pressure data. The mobile network uploads the historical temperature data and the historical pressure data with the incremental tire travel distance estimations and the tire-specific identification data to the remote server.

Pursuant to another aspect, the vehicle-based incremental vehicle travel distance estimator includes a vehicle-mounted sensor providing by vehicle CAN-Bus an incremental vehicle travel distance estimation and/or a global-positioning system providing an incremental vehicle travel distance estimation

### DEFINITIONS

“ANN” or “Artificial Neural Network” is an adaptive tool for non-linear statistical data modeling that changes its structure based on external or internal information that flows through a network during a learning phase. ANN neural networks are non-linear statistical data modeling tools used to model complex relationships between inputs and outputs or to find patterns in data.

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Dugoff Model” is an empirical tire model providing analytical relations for the longitudinal and lateral forces as functions of the slip angle and slip ratio. It accounts for the coupling between the side and longitudinal forces.

“Equatorial Centerplane (CP)” means the plane perpendicular to the tire's axis of rotation and passing through the center of the tread.

“Footprint” means the contact patch or area of contact created by the tire tread with a flat surface as the tire rotates or rolls.

“Groove” means an elongated void area in a tire wall that may extend circumferentially or laterally about the tire wall. The “groove width” is equal to its average width over its length. A grooves is sized to accommodate an air tube as described.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Outboard side” means the side of the tire farthest away from the vehicle when the tire is mounted on a wheel and the wheel is mounted on the vehicle.

“Peristaltic” means operating by means of wave-like contractions that propel contained matter, such as air, along tubular pathways.

“Piezoelectric Film Sensor” a device in the form of a film body that uses the piezoelectric effect actuated by a bending of the film body to measure pressure, acceleration, strain or force by converting them to an electrical charge.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tread element” or “traction element” means a rib or a block element defined by having a shape adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIG. 1 is schematic of the subject system and method in which vehicle distance travelled information is taken off the CAN-Bus.

FIG. 2 is a schematic of the system and method in which the vehicle distance travelled information is taken off GPS.

### DETAILED DESCRIPTION OF THE INVENTION

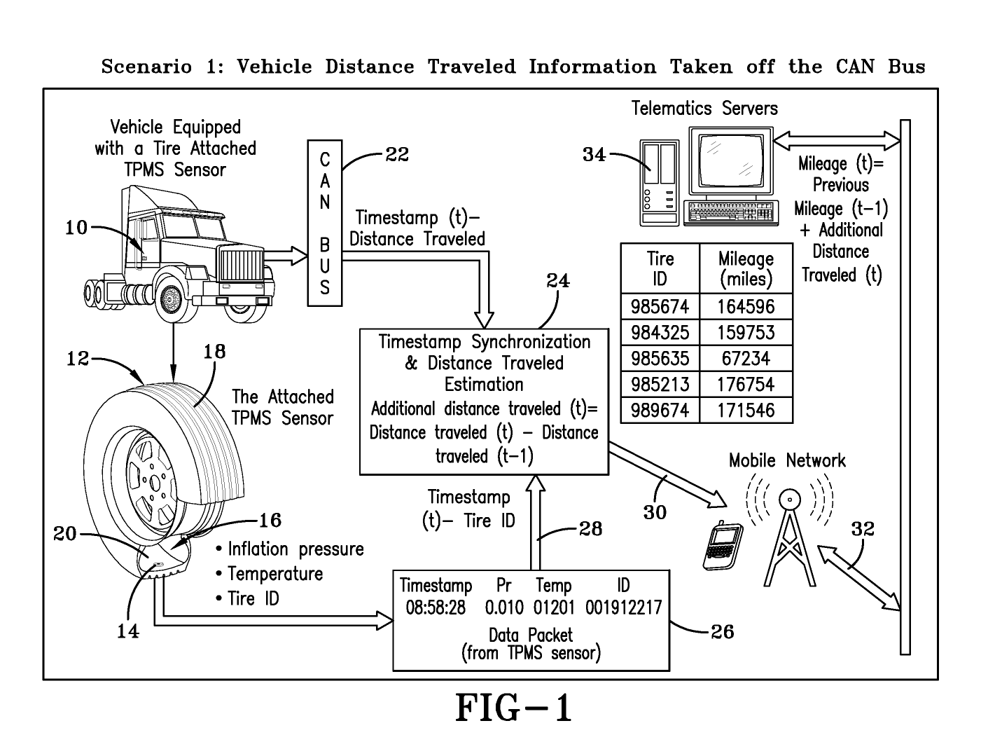

Referring to FIG. 1, a first embodiment of the tire tracking system and method is shown. A vehicle 10 is equipped with pneumatic tires 12. While vehicle 10 is seen as a commercial truck, other vehicle types are compatible with the use of the subject method and system. The tires 12 have respective dates of service implementation that may or may not coincide. Each tire 12 may accordingly have been placed into service at a different respective time. It is an objective of the subject system and method to monitor and track each tire 12 individually in order to record important historical information regarding each tire. Such information may include aggregate service mileage experienced by the tire, historical pressure data of the tire and/or historical temperature data of the tire. The information gathered and recorded may prove useful to monitor tire history and assist in determining when the tire needs replacement.

The tires 12 are of conventional pneumatic construction having a tread 18 and an air cavity 16. An inner liner 20 defines the cavity 16. A tire monitoring device 14 is affixed to the tire inner liner 20, hereinafter referred to as a “TPMS” sensor. The device 14 includes tire identification information by which each individual tire may be identified. The device 14 may further include a temperature sensor for monitoring the temperature of the tire and a tire pressure sensor for monitoring the air pressure within cavity 16. One or more transmitters are further included within the device 14 for wirelessly transmitting tire identification data, temperature data and pressure data. Collectively, the tire ID, temperature data and pressure data of the tire is referred herein as the “Data Packet” from the TPMS device 14.

The device 14 attaches to the tire inner liner 20 by suitable means such as an adhesive. The Data Packet from the TPMS device 14 is time stamped at time (t) as seen at block 26, wherein the pressure temperature and tire ID are recorded at a specific time (t). The time stamped Data Packet is input into a Timestamp Synchronization and Distance Traveled Estimation 24. The vehicle 10, in the first embodiment of the system shown in FIG. 1, is equipped with one or more sensors measuring vehicle distance travelled and providing via CAN-Bus 22 the measured vehicle distance travelled at Timestamp (t). The vehicle distance travelled at Timestamp (t) is input into the Timestamp Synchronization and Distance Travelled Estimation 24. The Timestamp Synchronization and Distance Travelled Estimation 24 takes the vehicle distance travelled at (t) since the last distance travelled at (t−1) and uploads the distance 30 to a Mobile Network 32. The Distance Travelled Estimation is then uploaded via the Mobile Network 32 to a Telematic Server 34 with the Data Packet for the tire. The Telematic Server 34 maintains a record of mileage (t)=previous for the tire, continuously updated by mileage (t−1+additional distance traveled (t). As seen in FIG. 1, recorded mileage for each tire is maintained and accessible by means of the Tire ID received telemetrically from the vehicle 10. The service mileage for each tire, along with historical pressure and temperature data from the Data Packet for the tire is accordingly accessible to assist fleet operators in assessing the history of each tire on a vehicle.

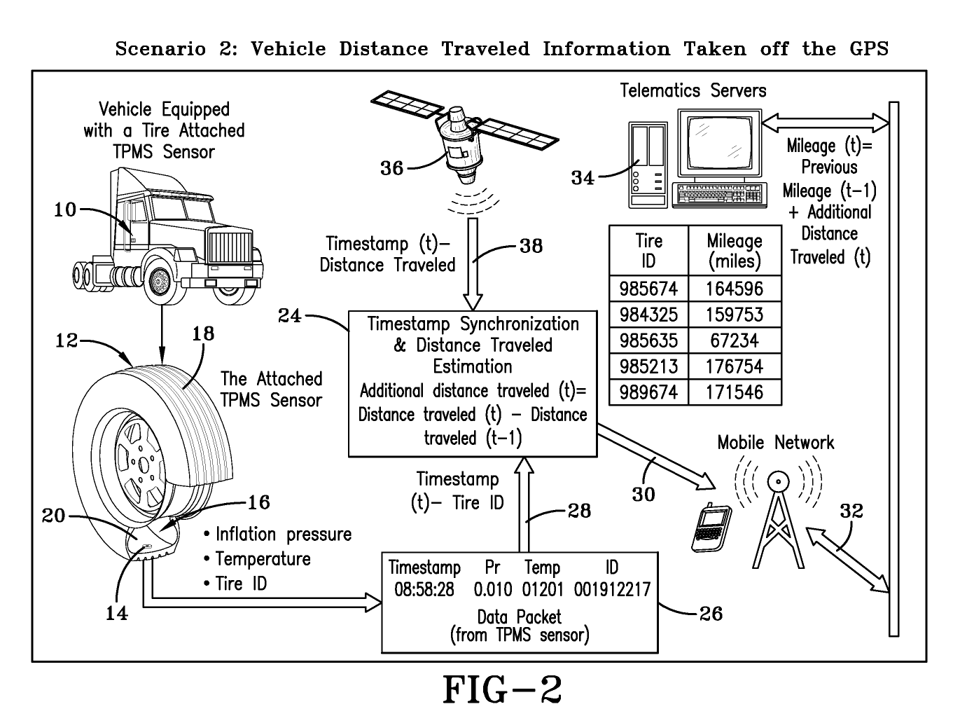

The alternative embodiment of the tire tracking system and method described above is seen in FIG. 2. In FIG. 2, the distance travelled by the vehicle is obtained through use of a GPS system 36. The Timestamp (t)—Distance Traveled input 38 obtained from the GPS system 36 inputs into the Timestamp Synchronization and Distance Traveled Estimation 24. As with the first embodiment of FIG. 1, the Data Packet from the TPMS system with the additional distance travelled is sent at 30 to the Telematic Server 34 by means of a Mobile Network 32.

GPS based estimates of vehicle speed may not be as reliable (e.g. issues with GPS signal drop off etc.) Accordingly, vehicle speed information on the CAN Bus may be preferable. CAN Bus information is based off wheel speed signals and the tire rolling radius (Vehicle speed=rolling radius×omega; where omega is the average of the 4 wheel speeds).

From the foregoing, it will be appreciated that the subject tire tracking system and method tracks travel mileage experienced by a vehicle tire and may further track historical information such as tire temperature and pressure history. The system includes a tire-affixed identification transponder, TPMS device 14. The Mobile Network 32 is operative to telemetrically transmit tire-specific identification data in a Data Packet to the remote Telematic Server 34. A Timestamp Synchronization and Distance Traveled Estimator 24 estimates additional distance travelled by the tire from either sensor-derived or GPS-derived vehicle distance travelled data. The remote server 34 stores the tire distance-travelled estimation in user accessible form, identified by a unique tire ID assigned to the tire.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire tracking system for tracking travel mileage experienced by a vehicle tire comprising:
a vehicle supported by at least one vehicle tire;
a tire-affixed identification transponder operative to generate tire-specific identification data;
a vehicle-based system operative to generate a synchronous stream of incremental vehicle travel distance estimations;
a timestamp synchronization and distance traveled estimator operative to estimate a synchronous stream of tire additional travel distance estimations based on the stream of incremental vehicle travel distance estimations;
a mobile network for uploading the tire additional travel distance estimations and the tire-specific identification data to a remote server;
wherein the remote server operatively aggregates a total tire distance from the uploaded tire additional travel distance estimations in a form accessible by the tire-specific identification data.

2. The tire tracking system of claim 1, wherein the vehicle-based system operative to measure incremental vehicle travel distance comprises at least one vehicle-mounted sensor providing by vehicle CAN-Bus an incremental vehicle travel distance estimation.

3. The tire tracking system of claim 1, wherein the vehicle-based system operative to measure incremental vehicle travel distance comprises a global positioning system providing an incremental vehicle travel distance estimation.

4. The tire tracking system of claim 1, wherein further comprising a tire-mounted pressure sensor operatively generating historical tire-specific inflation pressure data and wherein the mobile network is operative to upload the historical tire-specific inflation pressure data to the remote server with the tire additional travel distance estimation and the tire-specific identification data.

5. The tire tracking system of claim 1, wherein further comprising a tire-mounted temperature sensor operatively generating tire-specific historical temperature data and wherein the mobile network is operative to upload the historical tire-specific temperature data to the remote server with the tire additional travel distance estimation and the tire-specific identification data.

6. A tire tracking system for tracking travel mileage experienced by a vehicle tire comprising:
a vehicle supported by at least one vehicle tire;
a tire-affixed identification transponder operative to generate tire-specific identification data;
a vehicle-based incremental vehicle travel distance estimator for generating a synchronous stream of incremental vehicle travel distance estimations;
a timestamp synchronization and distance traveled estimator operative to generate a continuous synchronous stream of incremental tire travel distance estimations from the incremental vehicle travel distance estimations;
a mobile network for uploading the incremental tire travel distance estimations and the tire-specific identification data to a remote server;
wherein the remote server operatively generates an aggregate of the tire travel distance estimations in a form accessible by the tire-specific identification data.

7. The tire tracking system of claim 6, wherein further comprising:
a tire-mounted temperature sensor operatively generating tire-specific historical temperature data;
a tire-mounted pressure sensor operatively generating historical tire-specific inflation pressure data; and
wherein the mobile network uploads the historical temperature data and the historical pressure data with the incremental tire travel distance estimations to the remote server.

8. The tire tracking system of claim 6, wherein the vehicle-based incremental vehicle travel distance estimator comprises at least one vehicle-mounted sensor providing by vehicle CAN-Bus an incremental vehicle travel distance estimation.

9. The tire tracking system of claim 6, wherein the vehicle-based incremental vehicle travel distance estimator comprises a global-positioning system providing an incremental vehicle travel distance estimation

10. A method for tracking historical tire information comprising:
affixing an identification transponder to a vehicle tire operative to generate tire-specific identification data;
generating from a vehicle-based incremental vehicle travel distance estimator a synchronous stream of incremental vehicle travel distance estimations;
generating from a timestamp synchronization and distance traveled estimator a continuous synchronous stream of incremental tire travel distance estimations from the incremental vehicle travel distance estimations;
uploading through a mobile network the incremental tire travel distance estimations and the tire-specific identification data to a remote server;
generating from the remote server an aggregate of the tire travel distance estimations in a form accessible by the tire-specific identification data.

11. The method of claim 10, further comprising:
mounting a temperature sensor to the vehicle tire to operatively generate tire-specific historical temperature data;
mounting a pressure sensor to the vehicle tire to operatively generate historical tire-specific inflation pressure data; and
uploading through the mobile network the historical temperature data and the historical pressure data with the incremental tire travel distance estimations and the tire-specific identification data to the remote server.

12. The method of claim 10, wherein the vehicle-based incremental vehicle travel distance estimator comprises at least one vehicle-mounted sensor providing by vehicle CAN-Bus an incremental vehicle travel distance estimation.

13. The tire tracking system of claim 10, wherein the vehicle-based incremental vehicle travel distance estimator comprises a global-positioning system providing an incremental vehicle travel distance estimation.
